(19) United States
(12) Patent Application Publication
(10) Pub. No.: US 2025/0333243 A1
(43) Pub. Date: Oct. 30, 2025

(54) Induction Actuated Container

(71) Applicant: Nine Stars Group (U.S.A.) Inc., Ontario, CA (US)

(72) Inventors: Shi Ping WANG, Ontario, CA (US); Jiangqun CHEN, Fuzhou (CN)

(21) Appl. No.: 18/647,253

(22) Filed: Apr. 26, 2024

(51) Int. Cl. B65F 1/16; B65F 1/02

(52) U.S. Cl. CPC B65F 1/1638; B65F 1/02; B65F 1/1646; B65F 2210/168

(57) ABSTRACT

An induction actuated container includes a container body, an induction actuated container cover arranged on the container body, a cover panel, and a full-body induction arrangement received in a receiving chamber of an induction actuated container cover of the induction actuated container, which is configured to actuate an actuation unit to drive the cover panel between the close state to cover an inner cavity of the container body and the open state to open the inner cavity of the container body in response to an actuation movement applied to anywhere on an exterior surface of the induction actuated container.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to trash can, and more particularly to an induction actuated container equipping with a full-body induction arrangement to detect actuation movement applied to anywhere on the induction actuated container and open the cover panel of the induction actuated container and a control method of opening and closing of the cover panel of the induction actuated container.

### Description of Related Arts

U.S. Pat. Nos. 8,678,219 and 11,858,734 disclose a typical step-operated trash container which provide a foot pedal at a bottom portion allowing the user to step thereon to operate the opening and closing of the cover panel of the trash container.

U.S. Pat. Nos. 6,812,655, 7,598,693, 7,750,591, 8,129,930, and 10,822,165 disclose an induction actuated container which controls an opening and closing operation of a cover panel of the induction actuation container while detecting a target movement of a user by an infrared sensor provided on top of the induction actuated container. However, the sensing distance of the reflective infrared induction circuit can only be 28 cm in general.

U.S. Pat. Nos. 8,456,120, 8,547,049, 9,054,609, 10,526,139, and 11,008,163 disclose a touch actuated trash container which provide a foot touch panel at a bottom portion allowing the user to touch with his or her foot to operate the opening and closing of the cover panel.

No matter the step-actuated type, sensor type or touch panel type trash container, it merely provides a single way to trigger the opening of the cover panel. The user is required to actuate the opening of the cover panel within a specific area or operate the specific foot-pedal or foot touch panel in order to actuate the cover panel to open or close. Sometimes, the users may want to throw away the trash with a little farther from the trash container but the conventional trash container fails to fulfill such needs.

In addition, to the induction actuated container, either the infrared sensor type or the touch panel type, is not user's friendly to those users who are used to step on the mechanical foot pedal to open the cover panel with the habitual foot or to control the opening of the cover panel with the foot. It would be appreciated to all users if there is a trash container that allows the user to the open the cover panel by touching anywhere of the exterior surface of the trash container.

Furthermore, since the detection sensor of the induction actuated container frequently triggers the opening of the cover panel and the conventional control circuit of the induction actuated container consumes a large amount of power, especially for the induction actuated container that uses the battery as the power source, the battery needs to be replaced or recharged from time to time. How to reduce the power consumption of the control circuit during standby state of the induction actuated container and how to improve the utilization rate of the battery are long felt needs to the consumers.

### SUMMARY OF THE PRESENT INVENTION

The invention is advantageous in that it provides an induction actuated container which allows the user to actuate the opening of a cover panel thereof by touching, pressing, kicking or knocking anywhere of an exterior surface of the induction actuated container.

Another advantage of the invention is to provide an induction actuated container which allows the user to actuate the opening of the cover panel not only by contacting anywhere of the exterior surface of the induction actuated container, but also while the user is approaching the induction actuated container within a predetermined distance.

Another advantage of the invention is to provide a circuit control method of an induction actuated container, which not only allows the user to operate a control switch to determine whether an inductive actuation is activated to function to open and close its cover panel, but also greatly reduces the power consumption of the control circuit during the standby state and improves the utilization rate of the power source.

Another advantage of the invention is to provide an induction actuated container which is equipped with both remote inductive actuation and contact inductive actuation of the opening of the cover panel thereof such that the user may either actuate the cover panel to open when the user approaches within a detection range or actuate the cover panel to open by contacting anywhere of the exterior surface of the induction actuated container.

Another advantage of the invention is to provide an induction actuated container which allows the user to use both the contact inductive actuation and the remote inductive actuation to open the cover panel of the induction actuation container. For example, when the user is holding garbage or trash to be thrown away with both hand or has to throw away plenty of objects and requires more than couple seconds to complete the disposal operation, the user may apply an actuation movement such as foot kicking on anywhere of the induction actuated container to actuate an induction switch sensor unit to open the cover panel and continuously actuating the cover panel in the open state by actuating the infrared switch sensor unit simply by physically remaining in the detection range to keep the cover panel in the open state.

Another advantage of the invention is to provide an induction actuated container, wherein on the basis of infrared induction to actuate the opening of the cover panel, a control circuit thereof further includes a vibration switch sensor that allows the user to actuate the opening of the cover panel by contacting anywhere of the exterior surface of the trash container, such that the user may actuate or trigger the opening of the cover panel in both ways at the same time, including the first way that a target is close to the reflective infrared sensing window to trigger the opening of the cover panel of the induction actuated container, and the second way that the user gently touch or kick the induction actuated container with anything such as his or her foot, hand and an object to trigger the cover panel to open by means of the vibration switch sensor.

Additional advantages and features of the invention will become apparent from the description which follows, and may be realized by means of the instrumentalities and combinations particular point out in the appended claims.

According to the present invention, the foregoing and other objects and advantages are attained by an induction actuated container, comprising:
a container body having an inner cavity therein and a container opening;
an induction actuated container cover, including:
a control housing, defining a ring shape receiving chamber therein and having a cover opening, mounted on the container body;
a cover panel pivotally connected to the induction actuated container cover and configured to be selectively moved between a close state to cover the cover opening and the container opening so as to enclose the inner cavity and an open state to expose the inner cavity with outside through the container opening and the cover opening; and
an actuation unit received in the receiving chamber of the induction actuated container cover and configured to drive the cover panel between the close state and the open state; and
a full-body induction arrangement received in the receiving chamber of the induction actuated container cover and configured to actuate the actuation unit to drive the cover panel between the close state and the open state in response to an actuation movement applied to anywhere on an exterior surface of the induction actuated container.

In one embodiment, the full-body induction arrangement includes a vibration switch sensor unit, embodied as a low-power vibration switching circuit, configured to detect the actuation movement applied to the induction actuated container and a control circuit to actuate the actuation unit to drive the cover panel between the close state and the open state upon receiving a signal sent from an vibration switch sensor unit when the actuation movement applied to the induction actuated container is detected.

In one embodiment, the control circuit of the induction actuated container further comprises an infrared switch sensor unit provided on the induction actuated container cover and configured to actuate the actuation unit to open the cover panel when the infrared switch sensor unit detects a target approaching the infrared switch sensor unit.

In accordance with another aspect of the invention, the present invention provides a control method of an induction actuated container, comprising steps of.
(A) maintaining a control circuit of the induction actuated container in a shutdown mode while the induction actuated container is power on (i.e. the battery is loaded or AC power supply is connected thereto);
(B) actuating the control circuit in a standby mode when a control switch of the induction actuated container is actuated, such as being pressed for a short time; in other words, the cover panel will not be actuated to open even though the one or more batteries of the power source is loaded or the AC power supply is connected while the control switch is not actuated; and
(C) during the standby mode, actuating the cover panel to open for a predetermined period of time when an actuation movement applied to anywhere on the induction actuated container is detected by the vibration switch sensor unit, such as the user applying the actuation movement, such as touching with pressure, pressing, kicking, or knocking, against anywhere of an exterior surface of the induction actuated container.

In one embodiment, the step (C) further comprises steps of:
(C1) sending an output signal from the vibration switch sensor unit when the actuation movement applied to the induction actuated container is detected;
(C2) triggering a micro controller, which can be embodied as a microcomputer control chip, to control an actuation unit to open a cover panel with respect to a container body of the induction actuated container;
(C3) controlling the actuation unit to close the cover panel with respect to the container body of the induction actuated container after the cover panel has been opened for the predetermined period of time; and
(C4) maintaining the vibration switch sensor unit to the standby mode after the cover panel is closed.

The control method of the induction actuated container further comprises a step of:
(D) in the standby mode, actuating the cover panel to open for the predetermined of time when the infrared switch sensor unit of the control circuit detects a target, such as a trash or a hand, approaches a reflective infrared induction window of the infrared switch sensor unit.

In one embodiment, the step (D) further comprises steps of:
(D1) sending an output signal from the infrared switch sensor unit when the target approaching the reflective infrared induction window within the detection range is detected;
(D2) triggering the micro controller to control the actuation unit to open the cover panel with respect to the container body of the induction actuated container;
(D3) controlling the actuation unit to close the cover panel with respect to the container body of the induction actuated container after the cover panel has been opened for the predetermined period of time; and
(D4) maintaining the vibration switch sensor unit to the standby mode after the cover panel is closed.

The control method of the induction actuated container further comprises a step of:
(E) in the standby mode, switching the induction trach container to a continuous open state, wherein the cover panel is retained in the open state once it is actuated to open until it is actuated to close again.

In one embodiment, the step (E) further comprises steps of:
(E1) in the standby mode, opening the cover panel when an actuation switch is actuated for a first time mode, for example pressing the actuation switch for a short period of time, and
(E2) closing the cover panel when the actuation switch is actuated again.

In one embodiment, the actuation switch and the control switch are embodied as the same button switch.

In one embodiment, the step (E1) further comprises triggering the micro controller to control the actuation unit to open the cover panel with respect to the container body of the induction actuated container when the actuation switch is actuated and retaining the cover panel in the open state before the actuation switch is actuated again.

In one embodiment, the step (E2) further comprises triggering the micro controller to control the actuation unit to close the cover panel with respect to the container body of the induction actuated container when the actuation switch is actuated again, wherein such normal open operation of the cover panel is adapted for frequent trash disposing condition.

The control method of the induction actuated container further comprises a step of:

(F) in the standby mode, actuating the control circuit of the induction actuated container to the shutdown mode when the actuation switch is actuated with a second time mode, such as pressing the actuation switch for a longer period of time, and actuating the control circuit of the induction actuated container to the standby mode when the actuation switch is actuated for the first time mode, such as pressing the actuation switch for a short period of time, wherein such operation is adapted for users who do not use the induction actuated container for a long time so as to reduce the power consumption.

The control method of the induction actuated container further comprises a step of:

(G) in the standby mode, switching the induction actuated container to a single function state by switching off the vibration switch sensor unit and turning off the vibration induction function.

In one embodiment, the step (G) further comprises switching off the vibration switch sensor unit by actuating the control switch for a third time mode, such as pressing the actuation switch for a long period of time, to turn off the vibration induction function, so that the induction actuated container merely maintains the infrared induction function.

The control method of the induction actuated container further comprises a step of:

(H) in the standby mode, switching the induction actuated container back to dual function state, wherein both the vibration switch sensor unit and the infrared switch sensor unit are switched on and both the vibration induction function and the infrared induction function are turned on.

In one embodiment, the step (H) further comprises switching on the vibration switch sensor unit again by the micro controller to turn on the vibration induction function of the induction actuated container by actuating the actuation switch for the third time mode again, such as pressing the actuation switch for a long period of time, such that the user may selectively control the switching on and off of the vibration switch sensor unit and the vibration induction function of the induction actuated container.

In order to reduce the standby current of the control circuit of the induction actuated container of the present invention, the vibration switch sensor unit is embodied as a low-power vibration switching circuit comprising a field effect transistor, a capacitor, a high-resistance resistor, and a pull-up resistor and pull-down resistor of a corresponding port pin of the micro controller.

Accordingly, when the vibration induction function is turned on, the pull-up resistor of the corresponding port pin of the micro controller is effected while the pull-down resistor is not effected, and that when the vibration induction function is turned off, the pull-up resistor of the corresponding port pin of the micro controller is not effect while the pull-down resistor is effected, wherein both the pull-up resistor and the pull-down resistor are components in micro controller which effective or noneffective can be controlled by the program of micro controller.

In one embodiment, the first time mode, second time mode and third of the actuating of the actuation switch can respectively be embodied as a short period of time T1, such as less than 3 second, a middle period of time T2, such as less than 7 seconds and more than 3 seconds, and a long period of time T3, such as more than 7 seconds.

In one embodiment, one or more indicator lights can be provided in the control circuit to illustrate the actuating time of the actuation switch via various lighting patterns accordingly for ease of the user to observe the respective first, second and third actuating modes of the actuation switch.

In one embodiment, the vibration switch sensor unit comprises a vibration switch sensor which is a normally closed type sensor having a higher sensitivity, wherein such normally closed type vibration switch sensor has two pins which are retained in connection state while there is no vibration detected, and will be instantaneously disconnected once a vibration of the induction actuated container is occurred.

In one embodiment, the control switch and the actuation switch are embodied as the same button switch that is actuated by short press (first time mode), middle press (second time mode) and long press (third time mode) to provide a single-key control of the turning on and off of the shutdown mode, the standby mode, the normally open state, the vibration induction function. Such one-key operation is simple in configuration and operation, so that it greatly reduces the standby current, reduces power consumption, and prolongs the battery life. The equipping of normally closed vibration switch sensor has a high sensitivity that ensures an opening of the cover panel in response to a gentle touch of any portion of the exterior surface of the induction actuated container.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an induction actuated container, in close state, according to a preferred embodiment of the present invention.

FIG. 2 is a perspective view of the induction actuated container, in open state, according to the above preferred embodiment of the present invention.

FIG. 3 is an exploded view of the induction actuated container according to the above preferred embodiment of the present invention.

FIG. 4 is an exploded view of an induction actuated container cover of the induction actuated container according to the above preferred embodiment of the present invention.

FIG. 5 is a partial perspective view illustrating the actuation unit received in the receiving chamber of the induction actuated container cover of the induction actuated container according to the above preferred embodiment of the present invention.

FIG. 6 is an enlarged view illustrating the actuation unit received in the receiving chamber of the induction actuated container cover of the induction actuated container according to the above preferred embodiment of the present invention.

FIG. 7 is a circuit block diagram of the control circuit of the of the induction actuated container according to the above preferred embodiment of the present invention.

FIG. 8 is an interface circuit diagram between a typical vibration switch sensor and a port pin of a micro controller.

FIG. 9 is a block diagram illustrating a circuit control method of the induction actuated container according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

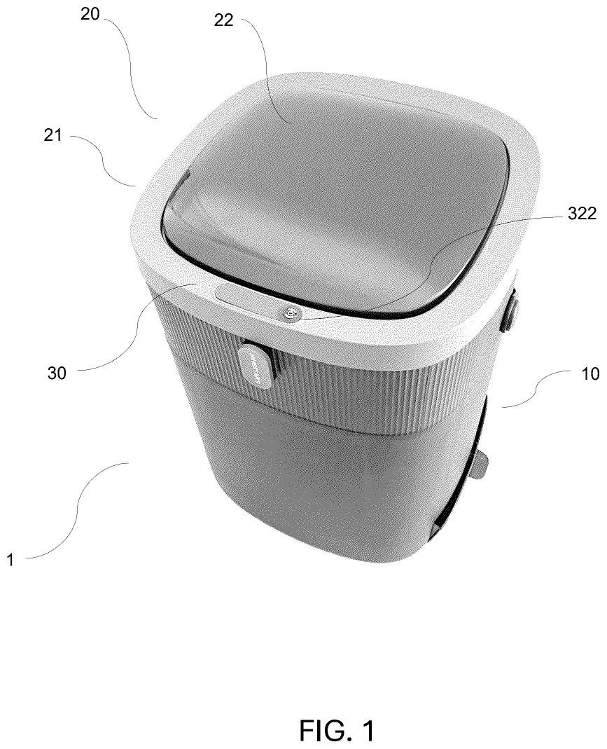

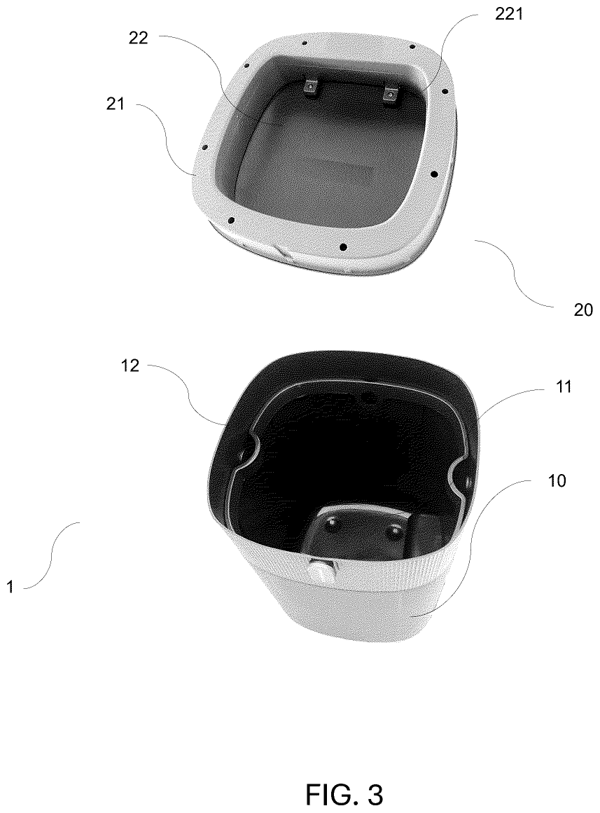

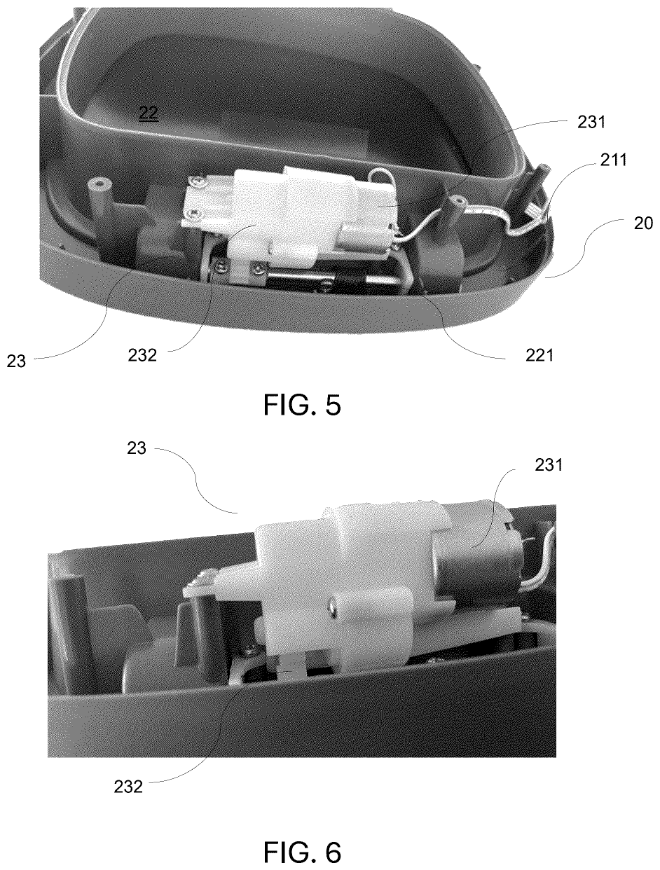

Referring to FIG. 1 to FIG. 9, an induction actuated container and a control method thereof are illustrated, wherein the induction actuated container 1 comprises a container body 10, an induction actuated container cover 20 and a full-body induction arrangement 30.

The container body 10 has an inner cavity 11 therein and a container opening 12. The induction actuated container cover 20 includes a control housing 21, a cover panel 22 and an actuation unit 23.

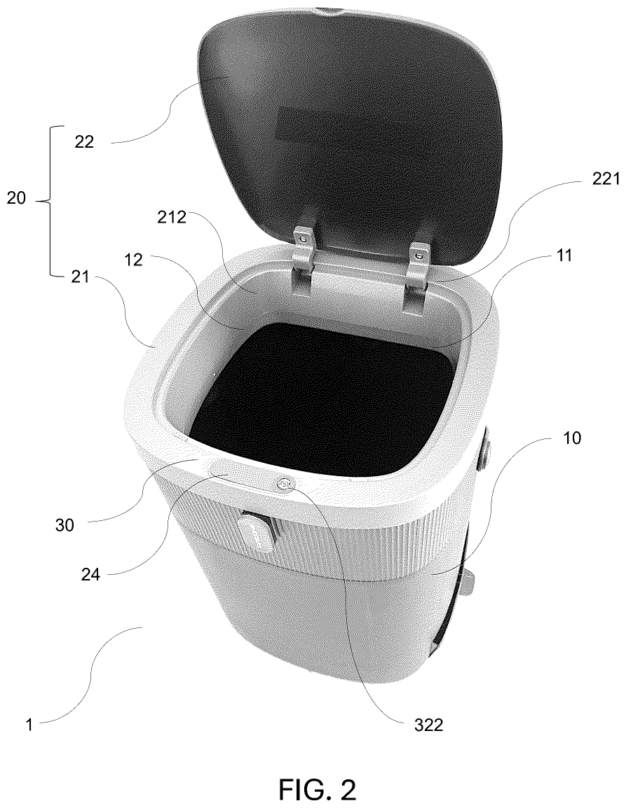

The control housing 21 which defines a ring shape receiving chamber 211 therein and has a cover opening 212 is mounted on the container body 10. The cover panel 22 is pivotally connected to the induction actuated container cover 20 via a hinge mechanism 221 installed between the cover panel 22 and the induction actuated container cover 21 and is configured to be selectively moved between a close state (as shown in FIG. 1) to cover the cover opening 212 and the container opening 12 so as to enclose the inner cavity 11 and an open state (as shown in FIG. 2) to expose the inner cavity 11 with outside through the container opening 12 and the cover opening 212.

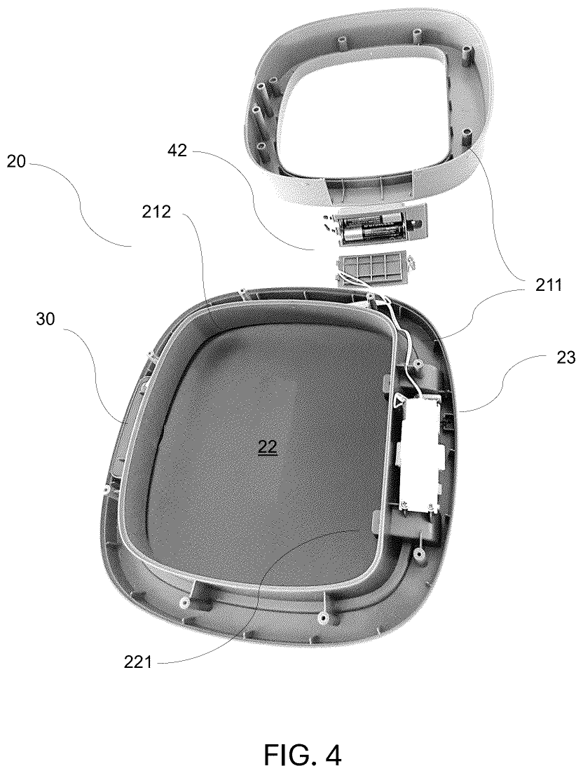

As shown in FIG. 4, the actuation unit 23 is received in a rear portion of the receiving chamber 211 of the control housing 21 of the induction actuated container cover 20, adjacent to the hinge mechanism 221 of the cover panel 22 and is configured to drive the cover panel 22 between the close state and the open state. The full-body induction arrangement 30 is received in the receiving chamber 211 of the induction actuated container cover 21 and configured to actuate the actuation unit 23 to drive the cover panel 22 between the close state and the open state in response to an actuation movement applied to anywhere on an exterior surface of the induction actuated container 1.

In other words, no matter the user presses, kicks or knocks on any position of the exterior surfaces of the container body 10, the cover panel 22 and the control housing 21 of the induction actuated container cover 21, the cover panel 22 will be driven by the actuation unit 23 to open responsively.

According to the preferred embodiment, the full-body induction arrangement 30 includes a vibration switch sensor unit 31 configured to detect the actuation movement, including but not limited to pressing, kicking or knocking, applied to the induction actuated container 1 and a control circuit 32 to actuate the actuation unit 23 to drive the cover panel 22 between the close state and the open state upon receiving a signal sent from the vibration switch sensor unit 31 when the actuation movement applied to the induction actuated container 1 is detected.

In order to reduce the standby current of the control circuit 32 of the induction actuated container 1 of the present invention, the vibration switch sensor unit 31 is preferred to be embodied as a low-power vibration switching circuit.

According to the preferred embodiment, the induction actuation container 1 further comprises an infrared switch sensor unit 41, which is embodied as an infrared induction circuit, provided on the induction actuated container cover 20 and arranged to actuate the actuation unit 23 to open the cover panel 22 when the infrared induction circuit 41 detects a target approaching the infrared induction circuit 41.

Referring to FIG. 4 to FIG. 8, according to the preferred embodiment, the infrared induction circuit 41 is embodied as an infrared induction circuit and the low-power vibration switching circuit 31. The control circuit 32 further includes a micro controller 321, a control switch 322, and a driving circuit 323. The actuation unit 23 includes an electric motor 231 and a reduction unit 232 including one or more gears arranged between the electric motor 231 and the hinge mechanism 221 of the cover panel 22 so as to reduce the output rotation speed of the motor 231 and convert the output rotation to the pivotally flipping up and down movement of the cover panel 22 with respect to the control housing 21.

The infrared induction circuit 41, which is a reflective infrared induction circuit, emits infrared rays pulse signals to an induction area 50 and receives reflected infrared ray pulse signals from the induction area 12 through an induction window 24 provided on a top surface of the control housing 21.

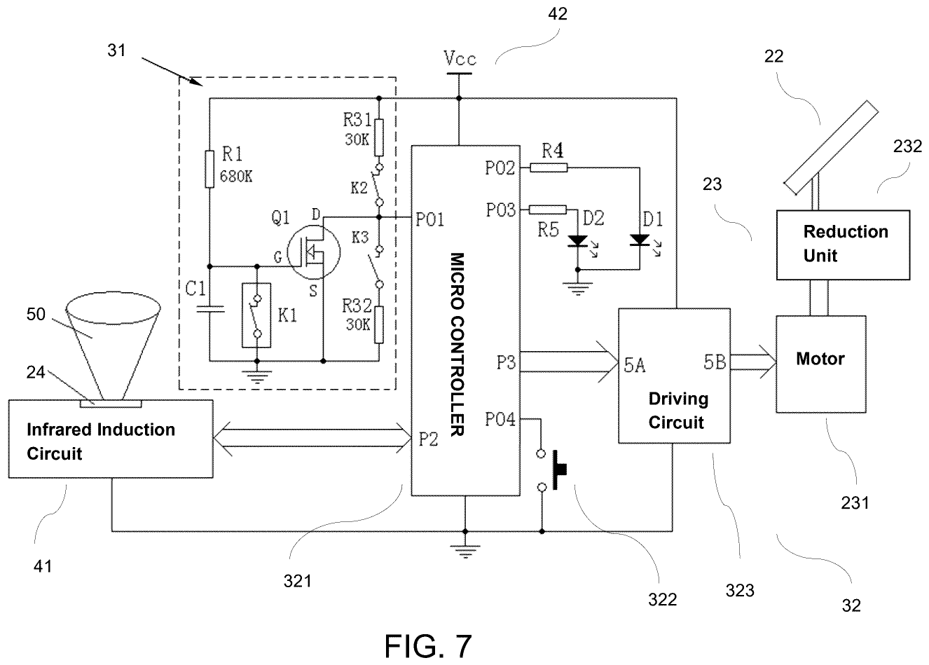

The lower-power vibration switching circuit 31 comprises a vibration switch sensor K1, preferably a normally closed type vibration switch sensor, a field effect transistor Q1, a capacitance C1, a resistor R1 of high resistance value, a pull-up resistor R31, and a pull-down resistor R32 at a port pin P01 of the micro controller 321 which is embodied as a microcomputer control chip, wherein switch K2 and switch K3 are also electronic switches in the micro controller 321 and the on/off of the switch K2 and the switch K3 can be set by the internal program of the micro controller 321. It is worth mentioning that the resistor R31, the resistor R32, the switch K2 and the switch K3 should be actually in the micro controller 321 but are illustrated outside the micro controller 321 in FIG. 7 merely for ease of illustration. Also, the capacitance C1 performs a filtering effect.

Referring to FIG. 4, the induction actuated container 1 of the present invention further comprises a power source 42 situated in the control housing 21 which is electrically connected with the low-power vibration switching circuit 31, the infrared induction circuit 41, the control circuit 32, and the motor 231 of the actuation unit 23 to provide electric power. The power source 42 may include one or more batteries or an AC terminal for connecting to an AC power supply (not shown).

When the one or more batteries of power source 42 are loaded or the AC power supply is connected to the power source 42, the control circuit 32 of the induction actuated container 1 is in shutdown mode during powering on. When the control switch 322, which is embodied as a button switch, is actuated by pressing for a short time, the control circuit 32 is actuated to a standby mode. In other words, the cover panel 22 will not be actuated to open even though the one or more batteries of the power source 42 is loaded or the AC power supply is connected therewith while the control switch 322 is not actuated, as shown in FIG. 1, FIG. 2, and FIG. 7.

In the standby mode, the full-body induction arrangement is also in an active state, wherein any actuation movement, such as touching with force or pressure, pressing, kicking, knocking, applied to the exterior surface of the induction actuated container 1 will actuate the cover panel 22 to open with respect to the control housing 21 of the induction actuated container cover 20, wherein the pull-up resistor R31 is effective, and the pull-down resistor R32 is not effective and that the internal program of the micro controller 321 controls the switch K2 being connected and the switch K3 being disconnected. Such that, the vibration switch sensor K1 is in a conduction state, the gate of the field effect transistor (MOSFET) Q1 is at a low level, the filed effect transistor Q1 is cut-off, the port pin P01 of the micro controller 321 remains in high-level state due to the effectiveness of the pull-up resistor R31 and the non-effectiveness of the pull-down resistor R32. During such condition, when a vibration signal is generated in the induction actuated container 1, such as being touched, pressed, kicked, or knocked by the user to anywhere on the exterior surface of the induction actuated container 1, the vibration switch sensor K1 is instantly disconnected and the gate G of the filed effect transistor (MOSFET) Q1 is in a high-level state instantly (because it is connected to the power supply Vcc through resistor R1), the filed effect transistor Q1 is on (the source S and the drain D of the field effect transistor Q1 are connected), the port pin P01 is instantly in low-level state, and the micro controller 321 receives the level change of the port pin P01 (from high level to low level). Then, the micro controller 321 starts its internal program and sends an output signal to an input port 5A of the driving circuit 323 from the port pin P3 of the micro controller 321. Then, the driving circuit 323 provides a positive voltage to the electric motor 231 through an output port 5B of the driving circuit 323, the motor 231 frontwardly rotates to drive the cover panel 22 to open via the reduction unit 232. The cover panel 22 opens for a delay period of time, embodied as approximately 4 seconds, the micro controller 321 is set to control the driving circuit 323 to supply a negative voltage to the electric motor 231 and the electric motor 231 reversely rotates to drive the cover panel 22 to close via the reduction unit 232, and the induction actuated container 1 returns to the standby mode and prepares for the next induction opening operation of the cover panel 22.

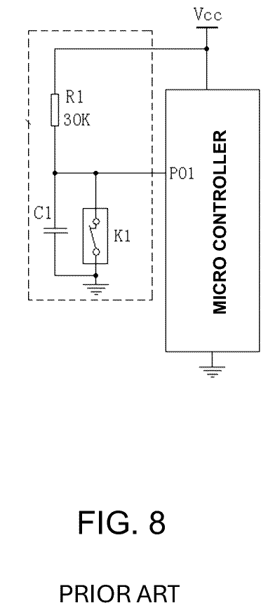

In particular, the port pin P01 of the micro controller 321 is set to an input port, such that if the pull-up resistance of the pull-up resistor R31 is too large, the port pin P01 cannot be determined to be the high-level state, so the resistance value of pull-up resistor R31 needs to be about 30Kω. According to FIG. 8, an interface circuit of typical vibration switch sensor K1 and the port pin P01 of the micro controller 321 is illustrated, wherein in the standby state of Vcc=3V, the standby current of the interface circuit of FIG. 2 is 3V=30K Ω=100 μA. It is appreciated, referring to FIG. 7, the low-power vibration switching circuit 31 according to the present invention is intervened by the field effect transistor Q1, so that the standby current of lower-power vibration switching circuit 31 is 3V÷680KΩ-4.4 μA, reducing from the 100 μA of the conventional circuit to 4.4 μA, so that the standby current of the interface circuit between the vibration switch sensor K1 and the port pin P01 of the micro controller 321 is greatly reduced, and the service life of the one or more batteries of the power source 42 is prolonged.

Referring to FIG. 7, the control circuit 323 further comprises a predetermined number of indicator lights, including light D1 and light D2, embodied as LEDs, where light D1 is green light and light D2 is red light, and that a resistor R4 and a resistor R5 are current limiting resistors for D1 and D2 respectively.

According to the induction actuated container 1 of the present invention, the present invention provides a control method thereof, comprising steps of.
(A) maintaining the control circuit 322 of the induction actuated container 1 in a shutdown mode while the induction actuated container 1 is power on (i.e. the battery is loaded or AC power supply is connected thereto);
(B) actuating the control circuit 322 in a standby mode when the control switch 322 of the induction actuated container 1 is actuated, such as being pressed for a short time when the control switch 322 is embodied as the button switch; in other words, the cover panel 22 will not be actuated to open even though the one or more batteries of the power source 42 is loaded or the AC power supply is connected while the control switch 322 is not actuated; and
(C) actuating the cover panel 22 to open for a predetermined period of time, during the standby mode, when an actuation movement applied to anywhere on the induction actuated container 1 is detected by the vibration switch sensor unit 31, such as the user applying the actuation movement, such as touching with pressure, pressing, kicking, or knocking, against anywhere of an exterior surface of the induction actuated container 1.

According to the preferred embodiment, the step (C) further comprises steps of:
(C1) sending an output signal from the low-power vibration switching circuit 31 when the actuation movement applied to the induction actuated container 1 is detected;
(C2) triggering the micro controller 322, which can be embodied as the microcomputer control chip, to control an actuation unit 23 to open a cover panel 22 with respect to the container body 10 of the induction actuated container 1;
(C3) controlling the actuation unit 23 to close the cover panel 22 with respect to the container body 10 of the induction actuated container 1 after the cover panel 22 has been opened for the predetermined period of time; and
(C4) maintaining the low-power vibration switching circuit 31 to the standby mode after the cover panel 22 is closed.

According to the preferred embodiment, the control method of the induction actuated container further comprises a step of:
(D) in the standby mode, actuating the cover panel 22 to open for the predetermined of time when the infrared induction circuit 41 of the control circuit 32 detects a target, such as a trash or a hand, approaches a reflective infrared induction window 24 of the infrared induction circuit 41.

According to the preferred embodiment, the step (D) further comprises steps of:
(D1) sending an output signal from the infrared induction circuit 41 when the target approaching the reflective infrared induction window 24 within the detection range is detected;
(D2) triggering the micro controller 322 to control the actuation unit 23 to open the cover panel 22 with respect to the container body 10 of the induction actuated container 1;
(D3) controlling the actuation unit 23 to close the cover panel 22 with respect to the container body 10 of the induction actuated container 1 after the cover panel 22 has been opened for the predetermined period of time; and
(D4) maintaining the low-power vibration switching circuit 31 to the standby mode after the cover panel 22 is closed.

According to the preferred embodiment, the control method of the induction actuated container 1 further comprises a step of:
(E) in the standby mode, switching the induction trach container 1 to a continuous open state, wherein the cover panel 22 is retained in the open state once it is actuated to open until it is actuated to close again.

According to the preferred embodiment, the step (E) further comprises steps of:
(E1) in the standby mode, opening the cover panel 22 when an actuation switch 322 (which can be another control switch but is embodied as the same control switch 322 according to the preferred embodiment) is actuated for a first time mode, for example pressing the control switch 322 for a short period of time, and
(E2) closing the cover panel 22 when the control switch 322 is actuated again.

According to the preferred embodiment, the step (E1) further comprises a step of triggering the micro controller 322 to control the actuation unit 23 to open the cover panel 22 with respect to the container body 10 of the induction actuated container 1 when the control switch 322 is actuated and retaining the cover panel 22 in the open state before the control switch 322 is actuated again; and

According to the preferred embodiment, the step (E2) further comprises a step of triggering the micro controller 322 to control the actuation unit 23 to close the cover panel 22 with respect to the container body 10 of the induction actuated container 1 when the control switch 322 is actuated again, wherein such normal open operation of the cover panel 22 is adapted for frequent trash disposing condition.

According to the preferred embodiment, the control method of the induction actuated container 1 further comprises a step of:
(F) in the standby mode, actuating the control circuit 32 of the induction actuated container 1 to the shutdown mode when the control switch 322 is actuated with a second time mode, such as pressing the control switch 322 for a longer period of time, and actuating the control circuit 322 of the induction actuated container 1 to the standby mode when the control switch 322 is actuated for the first time mode, such as pressing the control switch 322 for a short period of time, wherein such operation is adapted for users who do not use the induction actuated container 1 for a long time so as to reduce the power consumption.

According to the preferred embodiment, the control method of the induction actuated container further comprises a step of:
(G) in the standby mode, switching the induction actuated container 1 to a single function state by switching off the low-power vibration switching circuit 31 to turn off a vibration induction function.

According to the preferred embodiment, the step (G) further comprises a step of switching off the low-power vibration switching circuit 31 by actuating the control switch 322 for a third time mode, such as pressing the actuation switch for a long period of time, to turn off the vibration induction function, so that the induction actuated container 1 merely maintains the infrared induction function.

According to the preferred embodiment, the control method of the induction actuated container further comprises a step of:
(H) in the standby mode, switching the induction actuated container 1 back to a dual function state, wherein both the low-power vibration switching circuit 31 and the infrared induction circuit 41 are switched on and both the vibration induction function and the infrared induction function are turned on.

According to the preferred embodiment, the step (H) further comprises a step of switching on the low-power vibration switching circuit again by the micro controller 321 to turn on the vibration induction function of the induction actuated container 1 by actuating the control switch 322 for the third time mode again, such as pressing the control switch 322 for a long period of time, such that the user may selectively control the switching on and off of the low-power vibration switching circuit 31 and the vibration induction function of the induction actuated container 1.

In other words, when the vibration induction function is turned on, the pull-up resistor R31 of the corresponding port pin P01 of the micro controller 321 is effected while the pull-down resistor R32 is not effected, and that when the vibration induction function is turned off, the pull-up resistor R31 of the corresponding port pin P01 of the micro controller 321 is not effect while the pull-down resistor R32 is effected, wherein both the pull-up resistor R31 and the pull-down resistor R32 are components in the micro controller 321 which effective or noneffective can be controlled by the program of micro controller 321.

According to the preferred embodiment, the first time mode, second time mode and third of the actuating of the actuation switch can respectively be embodied as a short period of time T1, such as less than 3 second, a middle period of time T2, such as less than 7 seconds and more than 3 seconds, and a long period of time T3, such as more than 7 seconds.

The two indicator lights D1, D2 are provided in the control circuit 321 to illustrate the actuating time of the control switch 322 via various lighting patterns accordingly for ease of the user to observe the respective first, second and third actuating modes of the actuation switch.

It is worth mentioning that the low-power vibration switching circuit 31 is a normally closed type vibration switch sensor unit which has a higher sensitivity, wherein such normally closed type vibration switch sensor unit has two pins retained in connection state while there is no vibration detected, and will be instantaneously disconnected once a vibration of the induction actuated container 1 is occurred.

As mentioned above, the control switch and the actuation switch are embodied as the same button switch 322 that is actuated by short press (first time mode), middle press (second time mode) and long press (third time mode) to provide a single-key control of the turning on and off of the shutdown mode, the standby mode, the normally open state, the vibration induction function. Such one-key operation is simple in configuration and operation, so that it greatly reduces the standby current, reduces power consumption, and prolongs the battery life. The equipping of normally closed vibration switch sensor unit 31 has a high sensitivity that ensures an opening of the cover panel 22 in response to even a gentle touch of any portion of the exterior surface of the induction actuated container 1.

According to the preferred embodiment, the dual function mode not only allows the user to selectively using a contact inductive actuation to actuate the induction switch sensor unit 31 to open or close the cover panel 22 of the induction actuated container 1 by touching, pressing, kicking or knocking to the induction actuated container 1 or a remote inductive actuation by approaching the infrared switch sensor unit 41 within the detection range thereof to open or close the cover panel 22 of the induction actuation container 1, but also allows the user, who, for example, is holding garbage or trash to be thrown away with both hand or has to throw away plenty of objects and requires more than 4 seconds to complete the disposal operation, to apply the actuation movement such as foot kicking on anywhere of the induction actuated container 1 to actuate the induction switch sensor unit 31 to open the cover panel 22 and continuously actuating the cover panel 22 in the open state by actuating the infrared switch sensor unit 41, such as physically remaining in the detection range, to keep the cover panel 22 in the open state.

It is appreciated that when the micro controller 322 is used, the above control method can be processed by executing by an internal program of the micro controller 322 by means of a circuit control method, which includes the following steps when the induction actuated container 1 is power on:

S01: Control the circuits, including the low-power vibration switching circuit and the control circuit, in shutdown mode after the micro controller 321 is powered on.

S02: Determine whether the control switch 322 is actuated, wherein if the control switch 322 is not actuated, the circuits are retained in the shutdown mode, where both the indicator lights D1, D2 are off, and if the control switch 322 is actuated, such as being pressed down, light up the green indicator light D1 and wake up the micro controller 321 from the shutdown mode to execute the following step S03, and after the pressing down of the control switch 322 is released, extinguish the green indicator light D1 is extinguished).

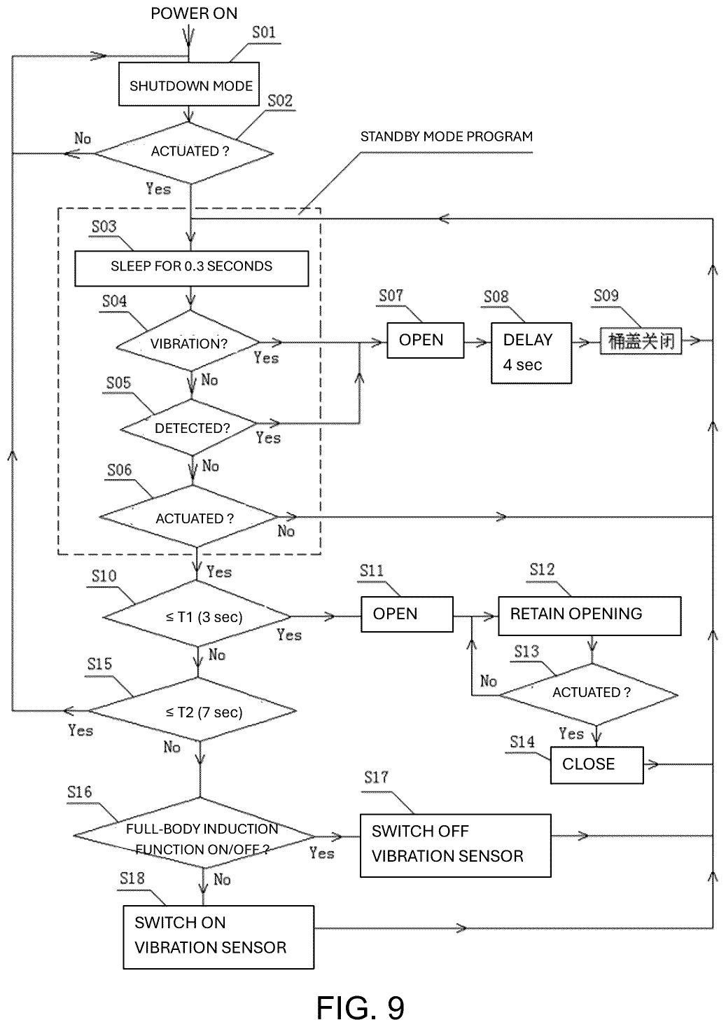

S03: Reduce a standby current of the circuits by having the micro controller 321 to sleep for a predetermined period of time, such as about 0.3 seconds, and then execute step S04, wherein the broken-line block in FIG. 9 is a block diagram of a standby mode program, and the 0.3 second sleep is to reduce the standby current of the circuit.

S04: Detect if there is a vibration signal of the induction actuated container 1, wherein if there is no vibration signal, perform step S05, if there is a vibration signal, execute step S07.

S05: Detect if there is an infrared sensing signal, perform the S06 step if there is no infrared induction, and execute the S07 step if there is an infrared sensing signal.

S06: Detect whether the control switch 322 is actuated, i.e, wherein the control switch 322, embodied as a button switch being pressing down, wherein if not, return to the step S03, if it is actuated, the green indicator light D1 is lighted, and executed step S10 step.

S07: Drive the cover panel 22 to the open statute by forwardly rotating the electric motor 231 to drive the cover penal 22 to open via the reduction unit 232 and execute step S08.

S08: Retain the cover panel 22 being opened for a predetermined period of time, such as approximately 4 seconds, waiting for the trash or garbage to be disposed into the inner cavity 11 of the container body 10 through the cover opening 22 and the container opening 12, and then execute step S09.

S09: Drive the cover panel 22 to the close state by reversely rotating the electric motor 231 to drive the cover panel 22 to close via the reduction unit 232, and return to the step S03.

S10: Determine whether an actuation time of control switch 322 is less than a first predetermined period of time T1 (T1=3 seconds), such as the button switch type control switch 322 is pressing down for the first predetermined period of time; if it is less than T1 (T1=3 seconds), execute step S11; if it is greater than T1 (T1=3 seconds), the green indicator light D1 is off and the red indicator light D2 is on, and then execute step S15.

S11: Drive the cover panel 22 to the open state by forwardly rotating the electric motor 231 to drive the cover panel 22 to open via the reduction unit 232, and execute step S12.

S12: Retain the cover panel 22 in the open state at all times.

S13: Determine whether the control switch 322 is remained in the open state, wherein keep in the step S12 that continuously retains the cover panel 22 in the open state, when there is no actuation to the control switch 322 (no pressing down to the button switch type control switch 322), or execute step S14 if an actuation movement is detected applied to the control switch 322 (there is a pressing down to the button switch type control switch 322).

S14: Drive the cover panel 22 to the close state by reversely rotating the electric motor 231 to close the cover panel 22 via the reduction unit 232, and returns to the step S03.

S15: Determine whether the actuation time of the control switch 322 is less than a second predetermined period of time T2 (T2=7 seconds), such as the button switch type control switch 322 is pressing down for the second predetermined period of time; if it is less than T2 (T2=7 seconds), execute the step S01 and enter the shutdown mode; if it is greater than T2 (T2=7 seconds), execute step S16.

S16: Determine whether a vibration induction function is on or not; if the original vibration induction function is on, the red indicator light D2 flashes, and execute step S17 to turn off the vibration induction function; if the original vibration induction function is off, the green indicator D1 flashes, and execute the S18 step to turn on the vibration induction function.

S17: Turn off the vibration induction function, wherein the micro controller 322 is set to have the pull-up resistor R31 and the pull-down resistor R32 connected to the port pin P01 of the micro controller 322 effective and not effective respectively, and then after the actuation movement of the control switch 322 is released, execute the step S03 and return to the standby mode.

S18: Turn on the vibration induction function, wherein the micro controller 322 is set to have the pull-up resistor R31 and the pull-down resistor R32 connected to the port pin P01 of the micro controller 322 effective and not effective respectively, and then after the actuation movement of the control switch 322 is released, execute the step S03 and return to the standby mode.

Accordingly, in standby mode, the cover panel 22 can be selectively operated between the continuous open state, shutdown mode, single function state and the dual function state:

(1) Press the button switch type control switch 322 for a short time (first time mode). As long as the pressing time is less than 3 seconds, the green indicator light D1 remains lighting within 3 seconds, such that while the control switch 322 is released within such 3 seconds, and the program enters the continuous open state that the cover panel 22 is retained in the open state.

(2) Press the control switch 322 for a longer time (second time mode). When the press time is within 3 seconds ˜7 seconds, the green indicator light D1 is extinguished and the red indicator light D2 is lighted, such that after the control switch 322 is released within the second time mode, the micro controller 321 enters the shutdown mode.

(3) Press the control switch 322 for a long time (third time mode). When the pressing time is greater than 7 seconds, if the vibration induction function is originally in the turn on state, the red indicator light D2 flashes, and after the control switch 322 is released, the micro controller 321 turns off the vibration induction function.

According to the preferred embodiment, according to the length of pressing time of the control switch 322, the indicator lights D1 and D2 in the control circuit 32 will have different changes, such that the user can observe different changes of the indicator lights D1, D2, to determine whether the induction actuated container 1 is operated to the short first time mode, the longer second time mode or the long third time mode.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An induction actuated container, comprising:
a container body having an inner cavity therein and a container opening;
an induction actuated container cover, including:
a control housing, defining a ring shape receiving chamber therein and having a cover opening, mounted on said container body;
a cover panel pivotally connected to said induction actuated container cover and configured to be selectively moved between a close state to cover said cover opening and said container opening so as to enclose said inner cavity and an open state to expose said inner cavity with outside through said container opening and said cover opening; and
an actuation unit received in said receiving chamber of said induction actuated container cover and configured to drive said cover panel between the close state and the open state; and
a full-body induction arrangement received in said receiving chamber of said induction actuated container cover and configured to actuate said actuation unit to drive said cover panel between the close state and the open state in response to an actuation movement applied to anywhere on an exterior surface of said induction actuated container.

2. The induction actuated container, as recited in claim 1, wherein said full-body induction arrangement includes a vibration switch sensor unit configured to detect the actuation movement applied to said induction actuated container and a control circuit configured to actuate said actuation unit to drive said cover panel between the close state and the open state upon receiving a signal sent from said vibration switch sensor unit when the actuation movement applied to the induction actuated container is detected.

3. The induction actuated container, as recited in claim 2, wherein said control circuit includes a micro controller and a driving circuit, wherein said vibration switch sensor is a low-power vibration switching circuit comprising a vibration switch sensor, a field effect transistor, a capacitor, a high-resistance resistor, and a pull-up resistor and a pull-down resistor of a corresponding port pin of said micro controller, wherein said actuation unit comprises an electric motor and a reduction unit.

4. The induction actuated container, as recited in claim 3, wherein in a standby mode while the induction actuated container is power on, the actuation movement applied to said exterior surface of said induction actuated container actuates said cover panel to open with respect to said control housing of said induction actuated container cover, wherein said pull-up resistor is effective and said pull-down resistor is not effective and that said micro controller controls a first switch being connected and a second switch being disconnected, wherein said vibration switch sensor is in a conduction state, a gate of said field effect transistor is at a low level, said filed effect transistor is cut-off, and said corresponding port pin of said micro controller remains in high-level state due to an effectiveness of said pull-up resistor and a non-effectiveness of said pull-down resistor, such that when a vibration signal is generated in said induction actuated container due to the actuation movement applied to said induction actuated container, said vibration switch sensor is instantly disconnected and said gate of said filed effect transistor is in a high-level state instantly, said filed effect transistor is on, said corresponding port pin is instantly in low-level state, and said micro controller receives a level change of said corresponding port pin and sends an output signal to an input port of said driving circuit from another port pin of said micro controller, wherein said driving circuit provides a positive voltage to said electric motor through an output port of said driving circuit to actuate said electric motor to frontwardly rotate to drive said cover panel to the open state via said reduction unit and said cover panel opens for a delay period of time, and then said micro controller is set to control said driving circuit to supply a negative voltage to said electric motor to actuate said electric motor to reversely rotate to drive said cover panel to the close state via said reduction unit, and that said induction actuated container returns to the standby mode and prepares for another induction opening operation of said cover panel.

5. The induction actuated container, as recited in claim 1, wherein said control circuit of the induction actuated container further comprises an infrared switch sensor unit provided on said induction actuated container cover and configured to actuate said actuation unit to open said cover panel when said infrared switch sensor unit detects a target approaching said infrared switch sensor unit.

6. The induction actuated container, as recited in claim 2, wherein said control circuit of the induction actuated container further comprises an infrared switch sensor unit provided on said induction actuated container cover and configured to actuate said actuation unit to open said cover panel when said infrared switch sensor unit detects a target approaching said infrared switch sensor unit.

7. The induction actuated container, as recited in claim 3, wherein said control circuit of the induction actuated container further comprises an infrared switch sensor unit provided on said induction actuated container cover and configured to actuate said actuation unit to open said cover panel when said infrared switch sensor unit detects a target approaching said infrared switch sensor unit.

8. The induction actuated container, as recited in claim 4, wherein said control circuit of the induction actuated container further comprises an infrared switch sensor unit provided on said induction actuated container cover and configured to actuate said actuation unit to open said cover panel when said infrared switch sensor unit detects a target approaching said infrared switch sensor unit.

9. A control method of an induction actuated container, comprising steps of:
(A) maintaining a control circuit of said induction actuated container in a shutdown mode while said induction actuated container is power on;
(B) actuating said control circuit in a standby mode when a control switch of said induction actuated container is actuated; and
(C) during the standby mode, actuating a cover panel of said induction actuated container to open for a predetermined period of time when an actuation movement applied to anywhere on said induction actuated container is detected by a vibration switch sensor unit.

10. The control method, as recited in claim 9, wherein the step (C) further comprises steps of:
(C1) sending an output signal from said vibration switch sensor unit, which is a low-power vibration switching circuit, when the actuation movement applied to said induction actuated container is detected;
(C2) triggering a micro controller to control an actuation unit to open said cover panel with respect to a container body of said induction actuated container;
(C3) controlling an actuation unit of said induction actuated container to close said cover panel with respect to said container body of said induction actuated container after said cover panel has been opened for the predetermined period of time; and
(C4) maintaining said vibration switch sensor unit to the standby mode after said cover panel is closed.

11. The control method, as recited in claim 10, further comprising a step of:
(D) in the standby mode, actuating said cover panel to open for the predetermined of time when an infrared switch sensor unit of said control circuit detects a target approaching said infrared switch sensor unit.

12. The control method, as recited in claim 11, wherein the step (D) further comprises steps of:
(D1) sending an output signal from said infrared switch sensor unit when the target approaching said infrared induction sensor unit within a detection range is detected;
(D2) triggering said micro controller to control said actuation unit to open said cover panel with respect to said container body of said induction actuated container;
(D3) controlling said actuation unit to close said cover panel with respect to said container body of said induction actuated container after said cover panel has been opened for the predetermined period of time; and
(D4) maintaining said vibration switch sensor unit to said standby mode after said cover panel is closed.

13. The control method, as recited in claim 12, further comprising a step of:
(E) in the standby mode, switching said induction trach container to a continuous open state, wherein said cover panel is retained in the open state once said cover panel is actuated to open until said cover panel is actuated to close again.

14. The control method, as recited in claim 13, wherein the step (E) further comprises steps of:
(E1) in the standby mode, opening said cover panel when said control switch is actuated for a first time mode, and
(E2) closing said cover panel when said control switch is actuated again.

15. The control method, as recited in claim 14, wherein the step (E1) further comprises triggering said micro controller to control said actuation unit to open said cover panel with respect to said container body of said induction actuated container when said control switch is actuated and retaining said cover panel in the open state before said actuation switch is actuated again, wherein the step (E2) further comprises triggering said micro controller to control said actuation unit to close said cover panel with respect to said container body of said induction actuated container when said control switch is actuated again.

16. The control method, as recited in claim 15, further comprising a step of:
(F) in the standby mode, actuating said control circuit of said induction actuated container to a shutdown mode when said control switch is actuated with a second time mode, and actuating said control circuit of said induction actuated container to the standby mode when said control switch is actuated for the first time mode.

17. The control method, as recited in claim 16, further comprising a step of:
(G) in the standby mode, switching said induction actuated container to a single function state by switching off said vibration switch sensor unit to turn off a vibration induction function of said induction actuated container.

18. The control method, as recited in claim 17, wherein the step (G) further comprises switching off said vibration switch sensor unit by actuating sad control switch for a third time mode to turn off the vibration induction function, so that said induction actuated container merely maintains an infrared induction function.

19. The control method, as recited in claim 18, further comprising a step of:
(H) in the standby mode, switching said induction actuated container back to a dual function state, wherein both said vibration switch sensor unit and said infrared switch sensor unit are switched on and both the vibration induction function and the infrared induction function are turned on.

20. The control method, as recited in claim 19, wherein the step (H) further comprises switching on said vibration switch sensor unit again by said micro controller to turn on the vibration induction function of said induction actuated container by actuating said control switch for the third time mode again.
